(19) United States
(12) Patent Application Publication
(10) Pub. No.: US 2026/0339634 A1
(43) Pub. Date: Oct. 29, 2026

(54) OPTIMIZING ALGORITHMS FOR TARGET PROCESSORS USING REPRESENTATION NEURAL NETWORKS

(71) Applicant: DeepMind Technologies Limited, London (GB)

(72) Inventors: Andrea Michi, London (GB); Daniel J. Mankowitz, Harpenden (GB); Anton Zhernov, London (GB); Marco Oreste Gelmi, London (GB); Marco Selvi, London (GB); Cosmin Paduraru, London (GB); Edouard Leurent, London (GB); Amol Balkishan Mandhane, London (GB); Shariq Nadeem Iqbal, London (GB); David Silver, Hitchin (GB); Martin Riedmiller, Balgheim (DE); Pushmeet Kohli, London (GB); Oriol Vinyals, London (GB)

(21) Appl. No.: 18/997,368

(22) PCT Filed: Jul. 21, 2023
(86) PCT No.: PCT/EP2023/070308

§ 371 Date: Jan. 21, 2025

Related U.S. Application Data
(60) Provisional application No. 63/391,276, filed on Jul. 21, 2022.

(51) Int. Cl. G06F 8/41

(52) U.S. Cl. CPC G06F 8/447

(57) ABSTRACT

Methods, systems, and apparatus, including computer programs encoded on computer storage media, for optimizing a target algorithm using a state representation neural network.

### CROSS-REFERENCE TO RELATED APPLICATION

This application claims priority to U.S. Provisional Application No. 63/391,276, filed on Jul. 21, 2022. The disclosure of the prior application is considered part of and is incorporated by reference in the disclosure of this application.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes a system implemented as computer programs on one or more computers in one or more locations that optimizes a target algorithm for execution on a target processor. That is, the system determines an optimized algorithm that satisfies the specification of the target algorithm but can be executed on the target processor with reduced latency, i.e., relative to an existing implementation of the target algorithm for the target processor.

In one aspect, a method includes receiving data specifying a target algorithm to be optimized for execution on a target processor, e.g., a target processor that has a particular architecture, and generating an assembly program that represents an optimized version of the target algorithm that is optimized for execution on target processor, e.g., on the particular architecture of the target processor. The assembly program includes a plurality of assembly instructions in an assembly programming language for the target processor and the generating includes repeatedly performing operations that include generating a candidate assembly program by adding a respective assembly instruction to the candidate assembly program at each of a plurality of time steps, including, at each of the plurality of time steps: generating a current state input specifying a current state of the candidate assembly program as of the time step, processing the current state input using a representation neural network that is configured to process the current state input to generate a state representation of the current state of the candidate assembly program; and selecting an assembly instruction from a set of assembly instructions in the assembly programming language using the state representation of the current state of the candidate assembly program; determining, for each of one or more of the time steps, a correctness measure for the candidate assembly program as of the time step that measures whether the candidate assembly program as of the time step, when executed on the target processor, generates outputs that match outputs generated by the target algorithm; and determining a latency measure that measures a latency of the candidate assembly program when executed on the target processor.

The subject matter described in this specification can be implemented in particular embodiments so as to realize one or more of the following advantages.

By optimizing an algorithm for a target processor prior to executing the algorithm on the target processor, the system can improve the runtime efficiency of the target processor, e.g., by decreasing the latency of workloads executed on the target processor. For example, many algorithms, e.g., sorting or hashing, are building blocks of many different computational workloads and, as a result, executing these algorithms with decreased latency can result in significant overall performance improvement.

More generally, as demand for computation grows, it has become critical for these algorithms to be as performant as possible. Conventional techniques for algorithm optimization have struggled to further optimize state-of-the-art algorithms that have already been highly optimized, e.g., based on heuristics.

The described system optimizes a target algorithm for execution on a target processor by representing the target algorithm as an assembly program in an assembly language that is specific to the particular architecture of the target processor. That is, the target processor has control unit(s), registers, arithmetic and logic unit(s), and memory constructed to enable the target processor to recognize and execute programming instructions defined by the assembly program. As such, optimizations of the target algorithm in assembly language are particularly adapted for the design and internal functioning (i.e. the architecture) of the target processor.

As a result, the system can optimize the algorithm at the lowest level of optimization, which provides the most headroom for efficiency improvements, i.e., relative to optimizing the algorithm by optimizing a program in a higher-level programming language. That is, as a result of the system optimizing the algorithm at the assembly level by representing the algorithm as an assembly program, the target processor can achieve significant latency gains without sacrificing accuracy when executing the target algorithm.

Moreover, the system uses state representations generated by a representation neural network to generate candidate assembly programs while searching for the optimized algorithm. By making use of the state representations and by training the representation neural network during the search, the system can more effectively search the space of both correct and incorrect programs as compared to existing techniques. In particular, generating an algorithm that is both correct and fast requires considering the combinatorial space of assembly instructions. The difficulty of this task arises not only from the size of this search space, but also from the nature of the reward function for the task. A single incorrect instruction in an assembly program can potentially invalidate the entire algorithm, making exploration in this space of games incredibly challenging. By effectively representing the state of the assembly program using the representation neural network, the system can effectively explore both correct and incorrect assembly programs to arrive at an optimized program that is correct and has reduced latency even for algorithms that have already been optimized using other approaches, e.g., sorting or hashing functions.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 is a diagram of an example algorithm optimization system.

FIG. 2 is a flow diagram of an example process for generating a candidate assembly program.

FIG. 3 shows an example architecture of the representation neural network.

FIG. 4 is a flow diagram of an example process for adding an instruction to a candidate assembly program.

Like reference numbers and designations in the various drawings indicate like elements.

### DETAILED DESCRIPTION

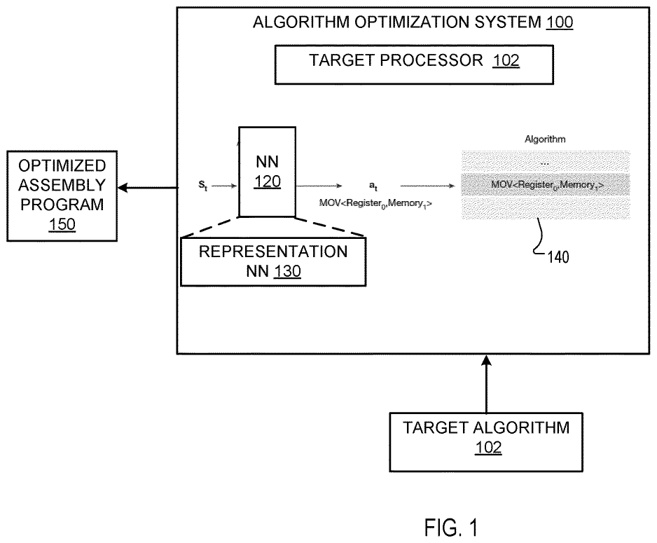

FIG. 1 shows an example algorithm optimization system 100. The algorithm optimization system 100 is an example of a system implemented as computer programs on one or more computers in one or more locations, in which the systems, components, and techniques described below can be implemented.

The algorithm optimization system 100 optimizes a target algorithm 102 for execution on a target processor 110.

The target processor 110 can generally be any appropriate computer processor having a particular architecture that performs computations using memory and registers.

For example, the target processor 110 can be a central processing unit (CPU) with a particular computer architecture, e.g., an x86 CPU or a RISC CPU.

As another example, the target processor 110 can be an application-specific integrated circuit (ASIC).

As yet another example, the target processor 110 can be a graphics processing unit (GPU) with a particular architecture.

In particular, the system 100 receives data specifying a target algorithm 102 and generates as output an optimized assembly program 150 that represents an optimized version of the target algorithm 102, i.e., that satisfies the specifications of the target algorithm 102 while having a reduced latency compared to other programs that also satisfy the specification of the target algorithm 102.

For example, an assembly program can be considered to satisfy the specification of an algorithm when the assembly program generates the same outputs as the algorithm for a given set of inputs when executed on the target processor 110. Thus, the optimized assembly program 150 generates the same outputs as the target algorithm 102 for a given set of inputs when executed on the target processor 110. As another example, the assembly program can be considered to satisfy the specifications of an algorithm when the outputs of the assembly program for a given set of inputs satisfy a property of the target algorithm 102. For example, for a hashing algorithm, the property can be satisfied when the number of collisions between hashes of the given set of inputs is below a threshold. As another example, for a compression algorithm, the property can be satisfied when the average reconstruction quality of reconstructions generated from compressed representations generated by the assembly program is above a threshold quality.

That is, the optimized assembly program 150 is one that can be executed more efficiently (in terms of latency) on the target processor 110 but that is still “correct” relative to the target algorithm 102.

Generally, the data specifying the target algorithm 102 can be any representation of the target algorithm 102 that contains sufficient information to allow the system 100 to determine what the output of the target algorithm 102 is for any given input.

For example, the system 100 can receive data specifying a higher-level program that represents the operations of the target algorithm 102 in a higher-level programming language, data specifying pseudo-code of the target algorithm 102, data specifying a mathematical formulation of the target algorithm 102, a list of the possible inputs to the algorithm and a corresponding output of the target algorithm 102 for the possible inputs, and so on.

Examples of target algorithms that can be optimized by the system include, but are not limited to, fixed sort algorithms for sorting various-sized sets of numbers, i.e., fixed length sequences of numbers, variable sort algorithms for sorting variable-sized sets of numbers, i.e., variable length sequences up to a specified maximum length, a Varint Deserialization algorithm, hashing algorithms for hashing input data, compression algorithms for compressing input data, and any of a variety of other algorithms.

An assembly program is a sequence of assembly instructions in an assembly language for the target processor 102. That is, the assembly program contains a sequence of assembly instructions and each assembly instruction in the program is an instruction selected from a set of assembly instructions.

Generally, the instructions in the set of assembly instructions are instructions that manipulate data between memory and registers of the target processor 102.

For example, the instructions in the set can include instructions that copy values from memory locations into registers, instructions that manipulate values between registers, instruction that return values from registers to memory locations, and so on.

As a particular example, the instructions can be of the format Opcode<OperandA, OperandB>. An example of such an instruction is mov<A, B> which is defined as moving a value from source (A) to destination (B). Additional examples include cmp<A, B>—compare whether the values A and B are equal and set a register flag accordingly; cmovX<A, B>—conditionally move the value from A to B if a register flag is set where X can be L (Less than), G (Greater than), LE (Less than or equal) or GE (Greater than or equal); or jX<A>—jump to a different part of the program defined by the label A. Here X can correspond to values such as NE (Not Equal), E (Equal) or can be left blank, in which case the jump will be executed regardless of the register flag. This instruction is used when there is branching such as if-else or switch-case statements in a C++ function.

To execute an assembly program on a target processor 102, the system 100 generates, from the assembly program, executable machine code for the target processor 102 and causes the target processor to execute the executable machine code to perform the target algorithm 102. For example, an assembler for the target processor 102 can convert the assembly program into executable machine code for the target processor 102.

The set of assembly instructions from which the instructions in the program can be selected can be received as an input by the system 100 and can be, e.g., the entire set of instructions in the assembly language of the target processor 102 or a subset of the instructions in the assembly language that have been identified as potentially being useful for carrying out the target algorithm 102.

By representing the target algorithm 102 as an assembly program in an assembly language that is specific to the target processor 110, the system 100 can optimize the algorithm at the lowest level of optimization, which provides the most headroom for efficiency improvements, i.e., relative to optimizing the algorithm 102 by optimizing a program in a higher-level programming language. That is, by optimizing the algorithm 102 at the assembly level by representing the algorithm 102 as an assembly program, the target processor 110 can achieve significant latency gains without sacrificing accuracy when executing the target algorithm 102.

To optimize the target algorithm, the system 100 repeatedly generates candidate assembly programs using a neural network (“NN”) 120 while also training the neural network 120 to generate more efficient but correct assembly programs. A “correct” assembly program is one that satisfies the specifications of the target algorithm 102.

In particular, the system 100 repeatedly generates candidate assembly programs using the neural network 120 and uses the generated candidate assembly programs to generate training data for training the neural network 120. The system 100 then intermittently trains the neural network 120 on the training data, so that the candidate assembly programs generated using the neural network 120 become more efficient as training progresses.

Because the system 100 trains the neural network 120 on the training data intermittently during the generation of candidate assembly programs, the candidate assembly programs generated by the system 100 using the neural network 120 will generally become more efficient while still generating correct outputs.

After training, the system 100 can select, as the optimized assembly program 150, one of the candidate programs that were generated during the training.

For example, the system 100 can select, from the candidate programs that satisfy the specifications of the target algorithm, the candidate program with the smallest latency. Alternatively, the system 100 can select, from the candidate programs, the candidate program for which the sum or weighted sum of a correctness measure and a latency measure is highest.

After selecting the optimized assembly program 150, the system 100 can generate, from optimized assembly program 150, executable machine code for the target processor 102. The system can cause the target processor to execute the executable machine code to perform the target algorithm 102. For example, an assembler for the target processor 102 can convert the optimized assembly program 150 into executable machine code for the target processor 102.

Alternatively or in addition, the system 100 can provide the optimized assembly program 150 or the executable machine code to another system for use in executing the target algorithm 102 on the target process 110.

Alternatively or in addition, the optimized assembly program 150 may be included in a programming language library. For example, the executable machine code may be included in a programming language library, such as a higher level programming language library.

Standard libraries provide building blocks of programs written in higher-level languages. By including the assembly program 150 in a library, the performance of any computer program that accesses the assembly program 150 in the library will be improved.

Generally, the system 100 generates a candidate assembly program by adding a respective assembly instruction to the candidate assembly program at each of a plurality of time steps using the neural network 120.

That is, the system 100 starts with an empty buffer and then iteratively adds instructions to the buffer using the neural network 120 to build the candidate assembly program.

For example, at a time step t when generating a candidate program 140, the system can generate a state input sₜ that specifies a current state of the candidate assembly program 140 as of the time step t and can select an assembly instruction aₜ that corresponds to the assembly instruction MOV<Register₀, Memory₁>, i.e., an instruction that moves data from register 0 to memory location 1, and can add the assembly instruction aₜ to the candidate assembly program 140.

The neural network 120 generally includes a representation neural network 130.

The representation neural network 130 is a neural network that is configured to receive a state input specifying a current state of a candidate assembly program as of the time step and to process the current state input to generate a state representation of the current state of the candidate assembly program.

The state representation is an ordered collection of numerical values, e.g., a vector or a matrix or a higher-order tensor, that represents the state of the candidate assembly program.

For example, the state input can include instruction data representing the instructions that are currently in the candidate assembly program and location data representing the state of the memory and the registers of the target processor 110. That is, the location data represents the state of the memory and the registers after executing the instructions that are currently in the candidate assembly program on a set of inputs for the target algorithm 102.

Generating the state representation and example architectures of the representation neural network 130 are described in more detail below.

The neural network 120 can also include one or more other components that are used by the system 100 to map the state representation of the state of a candidate assembly program to a new assembly instruction to be added to the candidate assembly program, i.e., after the last assembly program that is currently in the candidate assembly program.

For example, the neural network 120 can include a policy neural network that is configured to process the state representation to generate a probability distribution over the set of assembly instructions.

The system 100 can, for example, directly use the probability distribution generated by the neural network 120 to select the instruction to be added candidate assembly program or can perform a search of future states of the candidate assembly program using the representation neural network 120 and the policy neural network (and other components) and then select the instruction using the results of the search.

Generating candidate assembly programs using the neural network 120 is described in more detail below.

As a particular example, the system 100 can receive data specifying a target algorithm 102 that is not configured to be run by a target processor 110, e.g., because the target algorithm is represented in an assembly language that is not valid for the target processor 110, because the target algorithm in its current form requires hardware capabilities that are not present on the target processor 110, or because executing the target algorithm 102 on the target processor 110 exceeds a latency budget for the corresponding computation.

The system 100 can then determine an optimized assembly program as described above and then operate the target processor 110 using the optimized assembly program, e.g., by generating executable machine code for the target processor 102 and causing the target processor to execute the executable machine code to perform the target algorithm 102.

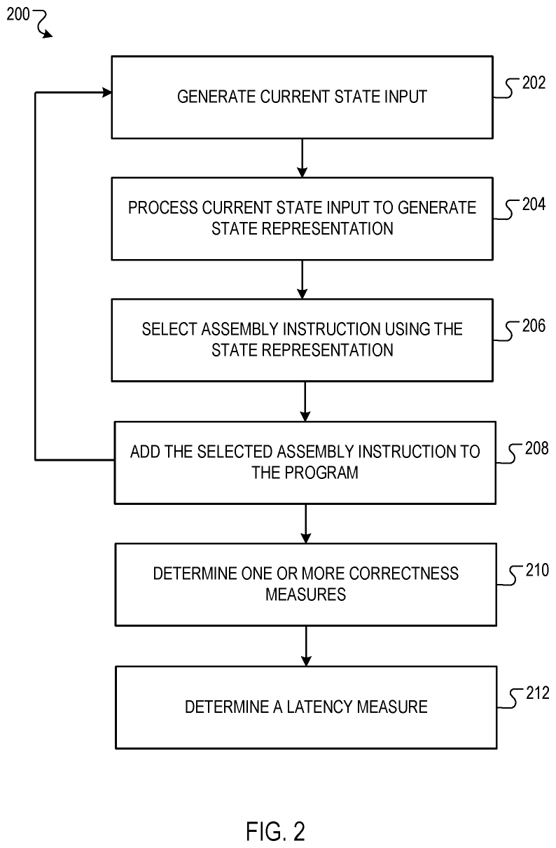

FIG. 2 is a flow diagram of an example process 200 for generating a candidate assembly program during training of the neural network. For convenience, the process 200 will be described as being performed by a system of one or more computers located in one or more locations. For example, an algorithm optimization system, e.g., the algorithm optimization system 100 depicted in FIG. 1, appropriately programmed in accordance with this specification, can perform the process 200.

In particular, as described above the system generates a candidate assembly program by adding a respective assembly instruction to the candidate assembly program at each of a plurality of time steps using the neural network.

At each of the plurality of time steps, the system can perform steps 202-208 to add a respective assembly instruction to the candidate assembly program. For example, the system can continue performing iterations of steps 202-208 until termination criteria are satisfied, e.g., until the candidate assembly program satisfies the specification of the target algorithm or until a maximum number of instructions are included in the candidate assembly program.

The system generates a current state input specifying a current state of the candidate assembly program as of the time step (step 202).

The system processes the current state input using a representation neural network that is configured to process the current state input to generate a state representation of the current state of the candidate assembly program (step 204).

The system then selects an assembly instruction from the set of assembly instructions in the assembly programming language using the state representation of the current state of the candidate assembly program (step 206).

For example, the system can perform a tree search using the state representation in order to select the assembly instruction to be added to the current candidate assembly program. Performing the tree search will generally make use of additional components of the neural network, i.e., components in addition to the representation neural network, e.g., one or more of a policy neural network, a dynamics neural network, or one or more value neural networks.

The policy neural network is a neural network, e.g., a feed-forward neural network, that is configured to receive a state representation and to process the state representation to generate a probability distribution over the set of assembly instructions.

The dynamics neural network is a neural network, e.g., a feed-forward neural network, that is configured to receive a state representation and data identifying an assembly instruction and to generate a predicted next state representation that represents the state of the program if the identified instruction is added to the program when the program is in the state represented by the input state representation.

In some implementations, the system uses two value neural networks: a latency neural network that predicts a latency return for the program given the current state and a correctness neural network that predicts a correctness return for the program given the current state.

The latency return is a prediction of the cumulative latency measures (described below) determined for the program after the program is in the current state. For example, when the latency measure is computed only at the last time step, the latency return is a prediction of the latency measure that will be computed at the last time step or of the latency measure multiplied by a discount factor.

The correctness return is a prediction of the cumulative correctness measures (described below) determined for the program after the program is in the current state. For example, when the correctness measure is computed only at the last time step, the latency return is a prediction of the correctness measure that will be computed at the last time step or of the correctness measure multiplied by a discount factor. When the correctness measure is computed at multiple time steps, the latency return is a prediction of the sum or the time-discounted sum of the future correctness measures computed at future time steps.

These other components of the neural network and example techniques for performing a tree search to select an action is described in Schrittwieser, et al., Mastering Atari, Go, Chess and Shogi by Planning with a Learned Model, at arXiv: 1911.08265, Schrittwieser, et al, Online and Offline Reinforcement Learning by Planning with a Learned Model, at arXiv:2104.006294, and Hubert, et al., Learning and Planning in Complex Action Spaces, at arXiv:2104.06303, all of which are hereby incorporated by reference herein in their entirety.

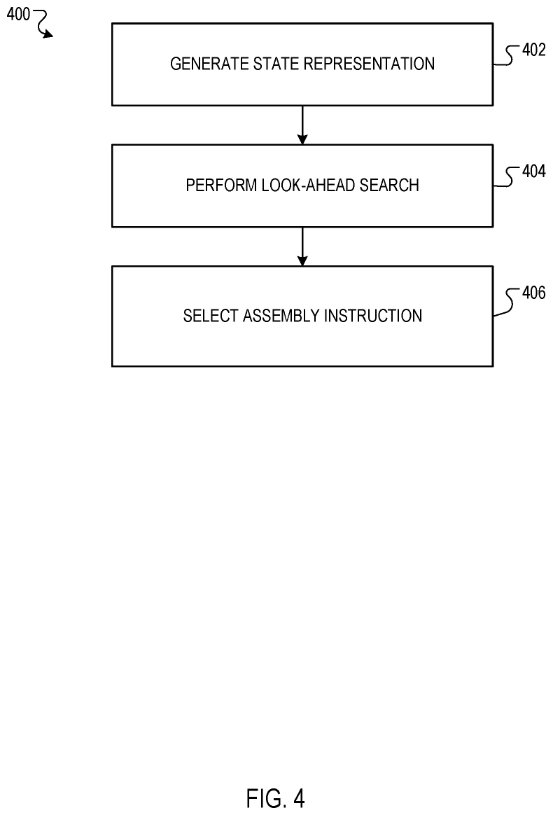

An example technique for performing the look-ahead search to select an action is described in more detail below with reference to FIG. 4.

As another example, the system can process the state representation of the current state using the policy neural network to generate a probability distribution over the set of assembly instructions. The system can then select the instruction to be added to the assembly program using the probability distribution, e.g., by selecting the instruction with the highest probability or by sampling from the distribution using an appropriate sampling technique. In some cases, the system can verify that the instruction is valid according to a known syntax or other constraint for the program prior to adding the instruction to the program.

The system then adds the selected assembly instruction to the assembly program, i.e., as the last instruction in the assembly program (step 208).

The system also determines, for each of one or more of the time steps at which an instruction was added, a correctness measure for the candidate assembly program as of the time step (step 210).

The correctness measure measures whether the candidate assembly program as of the time step, when executed on the target processor, generates outputs that match outputs generated by the target algorithm.

In some implementations, the system only computes the correctness measure at the last time step in the candidate program, i.e., after the last time step in the candidate assembly program.

In some other implementations, the system computes the correctness measure for multiple time steps in the candidate program, e.g., at each of the plurality of time steps at which instructions were added.

In some implementations, the correctness measure for a given time step is an absolute correctness measure that depends only on the performance of the program as of the given time step.

For example, the system can compute a respective individual absolute correctness measure for each given input in a set of one or more given inputs based on the degree to which the output generated by the program as of the time step for the given input matches the output of the target algorithm for the given input.

This individual absolute correctness measure can be a binary measure, e.g., equal to one if the outputs match exactly, or can be a more granular measure.

For example, for a sorting algorithm, the measure can be equal to the fraction of the inputs in the input sequence that are sorted into the correct position by the program as of the time step.

If there are multiple given inputs in the set, the system can then combine, e.g., average, the individual absolute correctness measures to generate the absolute correctness measure.

As another example, the measure can measure a degree to which outputs generated by the program have a particular property of outputs that are generated by the target algorithm. For example, for hashing algorithms, the correctness measure can measure the number of hashing collisions that occur between outputs of the assembly program for inputs in a given set of inputs. As another example, for compression algorithms, the correctness measure can measure a quality of reconstructions generated from compressed outputs of the assembly program generated for inputs in a given set of inputs.

In some other implementations, the correctness measure for a given time step is a relative correctness measure that depends on the absolute correctness measure for the program for the time step and the absolute correctness measures for the program at one or more earlier time steps. For example, the relative correctness measure can be equal to the absolute correctness measure for the given step minus the absolute correctness measure for the preceding time step. Thus, the relative correctness measure “rewards” improvement in the correctness of the program across time steps. For example, the relative correctness measure can be a function of the absolute correctness measure for the given step and the absolute correctness measure for the preceding time step, e.g., the difference between the two measures, a square root of the difference between the two measures, a difference between respective square roots of the two measures, and so on. Thus, the relative correctness measure “rewards” improvement in the correctness of the program across time steps.

The system also determines a latency measure that measures a latency of the candidate assembly program when executed on the target processor (step 212).

For example, the system can execute the candidate assembly program on the target processor as described above and measure the execution latency.

As another example, the system can determine a “proxy” latency measure from the number of instructions in the candidate assembly program, e.g., by assigning longer latency measures to longer programs. For example, the proxy latency measure can be equal to the number of instructions in the program or a different increasing function of the number of instructions.

The system can use the correctness measure(s) for the time step(s) and the latency measure for the program to generate training data for training the representation neural network and other components of the neural network, e.g., the policy neural network and, when included, the dynamics neural network, the one or more value neural networks, or both.

Generally, the system performs the training using reinforcement learning to optimize the latency and correctness returns. For example, the system can optimize a sum or a weighted sum of expected latency and correctness returns or can optimize both the latency and the correctness returns, e.g., through multi-objective reinforcement learning.

Example techniques for generating training examples and training the representation neural network and the other components of the neural network using the training examples are described in Schrittwieser, et al., Mastering Atari, Go, Chess and Shogi by Planning with a Learned Model, at arXiv: 1911.08265, Schrittwieser, et al., Online and Offline Reinforcement Learning by Planning with a Learned Model, at arXiv:2104.006294, and Hubert, et al, Learning and Planning in Complex Action Spaces, at arXiv:2104.06303, all of which are hereby incorporated by reference herein in their entirety.

When the system does not perform the look-ahead search and directly selects instructions using the probability distributions generated by the policy neural network, the system can train the policy neural network and the representation neural network using any appropriate reinforcement learning technique, e.g., a policy gradient technique, an actor-critic technique, and so on.

The system can intersperse steps of training the neural network between iterations of performing the process 200 to generate new candidate assembly programs. For example, the system can train the neural network after every n iterations of the process 200, where n is an integer greater than or equal one, or can add training examples generated as a result of performing the process 200 to a buffer and can asynchronously sample training examples from the buffer in order to perform training steps.

Because the system trains the neural network on the training data intermittently during the generation of candidate assembly programs, the candidate assembly programs generated by the system using the neural network will generally become more efficient while still generating correct outputs, i.e., due the neural network generating higher-quality outputs as training progresses.

After training, the system can select, as the optimized assembly program, one of the candidate programs that were generated during the training based on the correctness measures for the candidate programs and the latency measures for the candidate programs. For example, the system can select, from the candidate programs that have correctness measures that indicate that the optimized program satisfies the specifications of the target algorithm, the candidate program with the smallest latency measure.

Alternatively, after training has been completed, the system can generate a new assembly program using the trained neural network, i.e., by adding assembly instructions to the assembly program using the trained neural network as described above, and then select the new assembly program as the optimized assembly program.

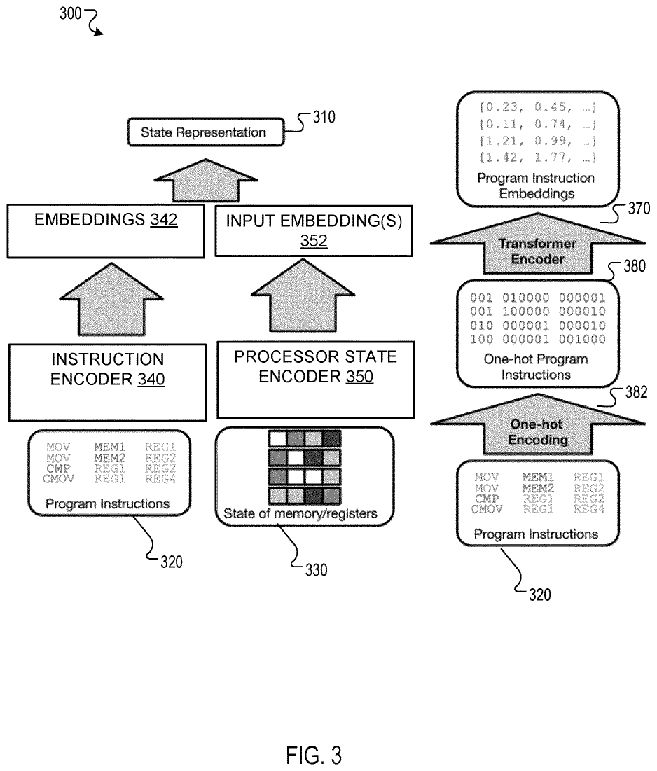

FIG. 3 shows an example architecture 300 of the representation neural network 130.

As described above, at any given time step, the representation neural network 130 receives a current state input specifying a current state of the candidate assembly program as of the time step and processes the current state input to generate a state representation 310 of the current state of the candidate assembly program.

Moreover, as described above, the current state input includes instruction data 320 representing the assembly instructions that are included in the candidate assembly program as of the time step and location data 330 representing a state of memory and registers of the target processor after executing the candidate assembly program as of the time step on a set of inputs.

In particular, the location data 330 can specify, for each of a set of inputs to the target algorithm and for each register and memory location of the target processor, the state of the register or memory location after the current assembly program as of the time step has been executed on the set of inputs, i.e., specify, for each input in the set, what value, if any, is stored in the register or memory location. That is, if there are k inputs in the set, the location data 330 includes k states for each register and memory location of the target processor. The set of inputs can include, e.g., all possible inputs to the target algorithm or a set of inputs that have been determined to be representative of the possible inputs to the target algorithm.

The representation neural network 130 can process the instruction data 320 using an instruction encoder 340 to generate a respective embedding 342 of each of the assembly instructions that are included in the candidate assembly program as of the time step.

In some implementations, the instruction encoder 340 is a Transformer encoder 370, i.e., a neural network that applies self-attention over the inputs to the neural network to generate as output a respective embedding of each of the inputs to the neural network.

In these implementations, the system can generate a respective encoding for each assembly instruction that is in the candidate assembly program as of the time step and process the respective encodings using the Transformer encoder 370 to generate the respective embeddings of the instructions.

As a particular example, the system can generate the respective encoding of each of the assembly instructions that are included in the candidate assembly program as of the time step from (i) respective one hot encodings 380 of each component of the assembly instruction and (ii) a positional encoding representing a position of the assembly instruction in the candidate assembly program as of the time step. The components of the instruction include the type of the instruction (“OpCode”) and the operands of the instruction, i.e., the memory locations, register locations, or both that are operated on by the instruction.

In the example of FIG. 3, there are 3 OpCodes (“mov,” cmp,” and “cmov”) and 6 different possible operands. Thus, the system first applies one-hot encoding 382 to encode each instruction as a concatenation of three one-hot vectors: a first one-hot vector with 3 entries encoding the OpCode, a second one-hot vector with 6 entries encoding the first operand, and a third one-hot vector with 6 entries encoding the second operand.

The system can then determine the encoding for each assembly instruction by combining, e.g., summing or averaging or concatenating, the concatenation of the one-hot encodings with the positional encoding for the position of the assembly instruction in the assembly program.

The system can generally use any appropriate positional encoding, e.g., learned encodings or pre-determined, e.g., sinusoidal, encodings, and the positional encodings can encode either the relative positions of the assembly instructions within the program or the absolute positions of the assembly instructions within the program.

In some implementations, the Transformer encoder 370 uses multi-query attention in order to increase computational efficiency. That is, in these implementations, the Transformer encoder 370 includes one or more multi-query attention blocks. Each multi-query attention block includes multiple self-attention heads that each have a respective learned query transformation but that share keys and values generated using a respective shared learned transformation that is shared between the attention heads.

In some other implementations, the instruction encoder 340 is a graph neural network, i.e., a neural network that applies one or more rounds of message passing on a graph representation of the input to generate a respective embedding for each node in the graph representation.

In these implementations, the system represents the current assembly program as a graph of nodes and edges.

Each node in the graph represents one of (i) a memory location of the target processor, (ii) a register location of the target processor, or (iii) a register flag.

Each edge in the graph represents data flow induced by a corresponding assembly instruction that is included in the candidate assembly program as of the time step.

The system generates, from the instruction data, node features for the nodes of the graph and edge features for the edges of the graph and then processes the data representing the graph, i.e., the node and edge features and the data identifying which nodes are connected by which edges, using a graph neural network to generate the respective embedding of each of the assembly instructions that are included in the candidate assembly program as of the time step.

For example, the respective node features for each node in the graph characterize values of the corresponding (i) memory location, (ii) register location, or (iii) register flag after processing each input in a set of inputs using the candidate assembly program as of the time step, i.e., as described above with respect to the location data.

The edge features for each edge in the graph include features of the instruction corresponding to the edge. For example, the features of the edge can include the instruction order, the instruction arguments, and the instruction type of the instruction corresponding to the edge.

In some cases, the graph data also includes one or more global features, e.g., a vector that summarizes information that characterizes the entire graph, e.g., the total number of nodes in the graph, the total number of edges in the graph, and so on.

The system then processes the graph data using the graph neural network to generate embeddings of each of the nodes in the graph, which the system uses as the embeddings 342 of the instructions in the assembly program.

The graph neural network can have any appropriate graph neural network architecture, e.g., can be any appropriate graph neural network that includes one or more graph neural network layers that apply any of a variety of message passing techniques to update the feature representations. Examples include those employed by Graph Attention Networks, Message Passing Neural Networks, Graph Convolutional Networks, and so on.

The representation neural network 130 can also process the location data 330 using a processor state encoder 350 to generate a set of one or more input embeddings 352.

For example, the processor state encoder 350 can be a multi-layer perceptron (MLP) or other feedforward neural network that processes the respective states of each register or memory location to generate a respective embedding for the register or memory location. As another example, the processor state encoder 350 can be a multi-layer perceptron (MLP) or other feedforward neural network that processes a concatenation of the respective states of each register or memory location to generate a single embedding that represents the states of all of the registers and memory locations.

The representation neural network 130 can then generate the state representation 310 from the embeddings 342 and the input embeddings 352 by combining the embeddings 342 and the input embeddings 352. For example, the representation neural network 130 can concatenate the embeddings 342 and the input embeddings 352 to generate the state representation. As another example, the representation neural network 130 can pool the embeddings 342 to generate a first pooled embedding, pool the input embeddings 352 to generate a second pooled embeddings, and then concatenate the first and second pooled embeddings to generate the input embeddings 352. As yet another example, the system can apply one or more learned operations, e.g., one or more fully-connected neural network layers, to the embeddings 342 and the input embeddings 352 to generate the state representation 310.

FIG. 4 is a flow diagram of an example process 400 for selecting an instruction to be added to a candidate assembly program at a given time step using a state representation. For convenience, the process 400 will be described as being performed by a system of one or more computers located in one or more locations. For example, an algorithm optimization system, e.g., the algorithm optimization system 100 depicted in FIG. 1, appropriately programmed in accordance with this specification, can perform the process 400.

The system generates a state representation of the state of the candidate assembly program as of the given time step (step 402), e.g., as described above with reference to FIGS. 2 and 3.

The state of the candidate assembly program at the given time step is represented by a root node in a state tree that includes nodes representing states of the candidate assembly program and edges representing instructions added to the candidate assembly program.

The system performs, using the state representation and starting from the root node in the state tree, a look-ahead search through the state tree (step 404).

For example, the system can perform a Monte Carlo Tree Search (MCTS) by, at each of multiple search iterations, traversing the state tree until a leaf node is reached. Once a leaf node is reached, the system can expand the leaf node and then terminate the search iteration. The system can continue performing search iterations until a budget for the tree search is exhausted.

During each search iteration, the system determines which edge to traverse from a given node using at least a probability distribution for the corresponding state generated by the policy neural network and the one or more returns generated by the one or more value neural networks.

For example, at each node, the system can select actions using an optimistic strategy called the predictor upper confidence tree bound (PUCT), meant to balance exploration (trying new actions) and exploitation (progressing further down the subtree of the current estimate of the best action). This strategy starts out by following the predicted policy closely, and gradually shifts towards maximizing the predicted value function.

In some implementations, the system evaluates the leaf node in the actual state space of the assembly program. That is, the system maintains an assembly program that has a state that corresponds to the state represented by the leaf node and determines which node is connected to the leaf node by a given edge by adding the corresponding instruction to the assembly program.

In some other implementations, the system performs the evaluation in the (latent) state representation space. In these implementations, the system uses the dynamics neural network to generate a predicted state representation for the node that is connected to the leaf node by the given edge by processing an input that includes a state representation corresponding to the leaf node and identifies the corresponding instruction.

Performing these look ahead searches performing a tree search to select an action is described in Schrittwieser, et al., Mastering Atari, Go, Chess and Shogi by Planning with a Learned Model, at arXiv: 1911.08265, Schrittwieser, et al, Online and Offline Reinforcement Learning by Planning with a Learned Model, at arXiv:2104.006294, and Hubert, et al., Learning and Planning in Complex Action Spaces, at arXiv:2104.06303, all of which are hereby incorporated by reference herein in their entirety.

As part of performing the look-ahead search, the system updates statistics for edges from the root node. For example, the system can maintain a visit count for each edge from the root node and can increment the visit count for a given edge from the root node whenever the edge is traversed during a search iteration.

After performing the search, the system selects, based on the statistics for edges from the root node after the look-ahead search is performed, the instruction from the set of instructions (step 406).

For example, as described above, the system can maintain a visit count for each edge that represents the number of times that the edge was traversed during the look-ahead search. The system can then assign, to each edge, a probability that is proportional to the visit count for the edge and then sample an edge in accordance with the probabilities.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework,. e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
receiving data specifying a target algorithm to be optimized for execution on a target processor; and
generating an assembly program that represents an optimized version of the target algorithm that is optimized for execution on the target processor, the assembly program comprising a plurality of assembly instructions in an assembly programming language for the target processor, the generating comprising repeatedly performing operations comprising:
generating a candidate assembly program by adding a respective assembly instruction to the candidate assembly program at each of a plurality of time steps, comprising, at each of the plurality of time steps:
generating a current state input specifying a current state of the candidate assembly program as of the time step,
processing the current state input using a representation neural network that is configured to process the current state input to generate a state representation of the current state of the candidate assembly program; and
selecting an assembly instruction from a set of assembly instructions in the assembly programming language using the state representation of the current state of the candidate assembly program;
determining, for each of one or more of the time steps, a correctness measure for the candidate assembly program as of the time step that measures whether the candidate assembly program as of the time step, when executed on the target processor, generates outputs that match outputs generated by the target algorithm; and
determining a latency measure that measures a latency of the candidate assembly program when executed on the target processor.

2. The method of claim 1, further comprising:
generating, from the assembly program, executable machine code for the target processor; and
causing the target processor to execute the executable machine code to perform the target algorithm.

3. The method of claim 1, wherein the current state input comprises instruction data representing the assembly instructions that are included in the candidate assembly program as of the time step, and wherein the representation neural network is configured to:
process the instruction data to generate a respective embedding of each of the assembly instructions that are included in the candidate assembly program as of the time step.

4. The method of claim 3, wherein:
the instruction data comprises respective node features for each node in a graph and respective edge features for each edge in the graph,
each node in the graph represents one of (i) a memory location of the target processor, (ii) a register location of the target processor, or (iii) a register flag, and
each edge in the graph represents data flow induced by a corresponding assembly instruction that is included in the candidate assembly program as of the time step.

5. The method of claim 4, wherein the representation neural network is configured to process the data representing the graph using a graph neural network to generate the respective embedding of each of the assembly instructions that are included in the candidate assembly program as of the time step.

6. The method of claim 4, wherein the respective node features for each node in the graph characterize values of the corresponding (i) memory location, (ii) register location, or (iii) register flag after processing each input in a set of inputs using the candidate assembly program as of the time step.

7. The method of claim 4, wherein the respective edge features for each edge in the graph comprise features of the instruction corresponding to the edge.

8. The method of claim 3, wherein the instruction data comprises a respective encoding of each of the assembly instructions that are included in the candidate assembly program as of the time step, and wherein the representation neural network is configured to process the respective encodings using a Transformer encoder neural network to generate the respective embedding of each of the assembly instructions that are included in the candidate assembly program as of the time step.

9. The method of claim 8, wherein the Transformer encoder neural network comprises one or more multi-query attention blocks.

10. The method of claim 8, wherein the respective encoding of each of the assembly instructions that are included in the candidate assembly program as of the time step is generated from (i) respective one hot encodings of each component of the assembly instruction and (ii) a positional encoding representing a position of the assembly instruction in the candidate assembly program as of the time step.

11. The method of claim 1, wherein the current state input comprises location data representing a state of memory and registers of the target processor after executing the candidate assembly program as of the time step on a set of inputs, and wherein the representation neural network is configured to:
process the location data to generate a set of input embeddings.

12. The method of claim 11 when dependent on claim 3, wherein the current state input comprises instruction data representing the assembly instructions that are included in the candidate assembly program as of the time step, wherein the representation neural network is configured to:
process the instruction data to generate a respective embedding of each of the assembly instructions that are included in the candidate assembly program as of the time step, and
process the set of input embeddings and the respective embeddings of each of the assembly instructions to generate the state representation.

13. The method of claim 1, wherein selecting an assembly instruction from a set of instructions in the assembly program language using the state representation generated by the neural network comprises:
performing, using the state representation generated by the neural network and starting from a root node representing a current state, a look-ahead search through a state tree that includes nodes representing states of the candidate assembly program and edges representing instructions added to the candidate assembly program; and
selecting, based on statistics for edges from the root node after the look-ahead search is performed, the assembly instruction from the set of instructions.

14. The method of claim 1, the operations further comprising:
generating, based on the latency measure, the correctness measure, and the assembly instructions added the program, a training example for training the neural network; and
adding the training example to training data for training the neural network.

15. The method of claim 14, further comprising:
training the neural network on training examples in the training data.

16. The method of claim 15, further comprising:
after training the neural network, selecting the assembly program from the candidate assembly programs generated by repeatedly performing the operations based on the correctness measures and the latency measures for the candidate assembly programs.

17. The method of claim 15, further comprising:
after training the neural network, generating the assembly program by adding assembly instructions to the assembly program using the trained neural network.

18. The method of claim 1, further comprising:
operating the target processor using the assembly program.

19. The method of claim 18, wherein operating the target processor comprises:
generating, from the assembly program, executable machine code for the target processor; and
causing the target processor to execute the executable machine code to perform the target algorithm.

20. The method of claim 18 or 19, wherein the target algorithm is not configured to be executed on the target processor prior to determining the assembly program.

21. A system comprising:
one or more computers; and
one or more storage devices storing instructions that, when executed by the one or more computers, cause the one or more computers to perform operations comprising:
receiving data specifying a target algorithm to be optimized for execution on a target processor; and
generating an assembly program that represents an optimized version of the target algorithm that is optimized for execution on the target processor, the assembly program comprising a plurality of assembly instructions in an assembly programming language for the target processor, the generating comprising repeatedly performing operations comprising:
generating a candidate assembly program by adding a respective assembly instruction to the candidate assembly program at each of a plurality of time steps, comprising, at each of the plurality of time steps:
generating a current state input specifying a current state of the candidate assembly program as of the time step,
processing the current state input using a representation neural network that is configured to process the current state input to generate a state representation of the current state of the candidate assembly program; and
selecting an assembly instruction from a set of assembly instructions in the assembly programming language using the state representation of the current state of the candidate assembly program;
determining, for each of one or more of the time steps, a correctness measure for the candidate assembly program as of the time step that measures whether the candidate assembly program as of the time step, when executed on the target processor, generates outputs that match outputs generated by the target algorithm; and
determining a latency measure that measures a latency of the candidate assembly program when executed on the target processor.

22. One or more computer-readable storage media storing instructions that when executed by one or more computers cause the one or more computers to perform operations comprising:
receiving data specifying a target algorithm to be optimized for execution on a target processor; and
generating an assembly program that represents an optimized version of the target algorithm that is optimized for execution on the target processor, the assembly program comprising a plurality of assembly instructions in an assembly programming language for the target processor, the generating comprising repeatedly performing operations comprising:
generating a candidate assembly program by adding a respective assembly instruction to the candidate assembly program at each of a plurality of time steps, comprising, at each of the plurality of time steps:
generating a current state input specifying a current state of the candidate assembly program as of the time step,
processing the current state input using a representation neural network that is configured to process the current state input to generate a state representation of the current state of the candidate assembly program; and
selecting an assembly instruction from a set of assembly instructions in the assembly programming language using the state representation of the current state of the candidate assembly program;
determining, for each of one or more of the time steps, a correctness measure for the candidate assembly program as of the time step that measures whether the candidate assembly program as of the time step, when executed on the target processor, generates outputs that match outputs generated by the target algorithm; and
determining a latency measure that measures a latency of the candidate assembly program when executed on the target processor.
